(19) United States
(12) Patent Application Publication
(10) Pub. No.: US 2017/0288426 A1
(43) Pub. Date: Oct. 5, 2017

(54) MULTI CHARGING DEVICE ENABLED BY CURRENT AND VOLTAGE CONTROL

(71) Applicants: Jae Beom KIM, Seoul (KR); PINCRAFT ENGINEERING INC., Anyang-si (KR)

(72) Inventor: Jae Beom KIM, Seoul (KR)

(73) Assignees: PINCRAFT ENGINEERING INC., Anyang-si (KR); Jae Beom KIM, Seoul (KR)

(21) Appl. No.: 15/475,053

(22) Filed: Mar. 30, 2017

(30) Foreign Application Priority Data
Mar. 31, 2016 (KR) 10-2016-0039665

(51) Int. Cl. H02J 7/00; H02J 7/04; H02J 7/02

(52) U.S. Cl. CPC H02J 7/0021; H02J 7/025; H02J 7/045; H02J 7/0044

(57) ABSTRACT

The present invention relates to a multi charging device enabled by current and voltage control and, most particularly, to a multi charging device enabled by current and voltage control being configured to include a main charging unit being capable of changing a charging speed, and an auxiliary charging unit being connected to the main charging unit by a wired connection and being incapable of changing the charging speed, wherein the main charging unit includes a power input module being supplied with power from an external power source, a voltage/current control module controlling voltage and current of the power being delivered from the power input module so as to vary the voltage and current, a variable charging module being supplied with voltage/current in accordance with a size that is varied by the voltage/current control module and performing wireless charging of devices, and a power output module being supplied with specific voltage/current controlled by the voltage/current control module and supplying power to the auxiliary charging unit, and wherein the auxiliary charging unit includes a non-variable charging module being supplied with the specific voltage/current from the power output module and performing wireless charging of devices.

This application claims the benefit of Korean Patent Application No. 10-2016-0039665, filed on Mar. 31, 2016, the contents of which are hereby incorporated by reference herein in their entirety.

### BACKGROUND OF THE INVENTION

### Field of the Invention

The present invention relates to a multi charging device enabled by current and voltage control and, most particularly, to a multi charging device enabled by current and voltage control being configured to include a main charging unit being capable of changing a charging speed, and an auxiliary charging unit being connected to the main charging unit by a wired connection and being incapable of changing the charging speed, wherein the main charging unit includes a power input module being supplied with power from an external power source, a voltage/current control module controlling voltage and current of the power being delivered from the power input module so as to vary the voltage and current, a variable charging module being supplied with voltage/current in accordance with a size that is varied by the voltage/current control module and performing wireless charging of devices, and a power output module being supplied with specific voltage/current controlled by the voltage/current control module and supplying power to the auxiliary charging unit, and wherein the auxiliary charging unit includes a non-variable charging module being supplied with the specific voltage/current from the power output module and performing wireless charging of devices.

### Discussion of the Related Art

Recently, with the expansion of the wireless charging technology market, the range of wireless charging targets has also become wider. Most particularly, with the consistent growth of wearable and healthcare industry markets, the request for wireless charging of diverse wearable devices has increased.

Wireless devices adopting the conventional wireless charging method require users to separately carry a wireless charging transmitter that is associated to each respective product, thereby causing limitations in mobility and installation space. Accordingly, an enhanced technology refraining from performing parallel usage of multiple charging devices and enabling simultaneous charging of diverse charging device structures is being devised.

For example, in the Korean Patent Application No. 2015-56222, entitled “Wireless power transmitting device capable of simultaneous multi-charging”, a wireless power transmitting device capable of simultaneous multi-charging, which may include a plurality of transmitting blocks each including two or more primary coils, and a transmission controller selecting a plurality of primary coils corresponding to a plurality of wireless power receiving devices by using a response signal from the plurality of primary coils each corresponding to a respective charging position, when each of the plurality of wireless power receiving devices is positioned at its corresponding charging position, and controlling the transmitting blocks so as to allow wireless power signals to be simultaneously transmitted from the selected plurality of primary coils, configures a main component of the invention. Herein, by dividing the wireless power transmitting device into transmitting blocks, initial standby power may be significantly reduced, efficiency in detecting foreign objects during charging may be increased, and power transmission efficiency from a power source may be increased.

However, the invention presented above is disadvantageous in that it merely corresponds to a simple parallel configuration of multiple charging units. And, most particularly, the invention presented above is disadvantageous in that each charging unit is equally provided with the same charging capability and that the invention merely corresponds to a simple technology of combining charging devices that can reduce power consumption by respectively replacing a plurality of charging devices with the plurality of charging units corresponding to the invention presented above.

Also, in the Korean Patent Application No. 1425603, entitled “Wireless charging method for simultaneous charging of multiple devices”, a method for charging a wireless charging device by a wireless power supplying device in a multi-node wireless power transmitting system including a wireless power supplying device and a plurality of wireless charging devices each being spaced apart from the wireless power supplying device and each performing wireless communication with the wireless power supplying device is configured to include a step of transmitting wireless power to the wireless charging devices to each of two or more slots during a power transmission section, the power transmission section being divided into two or more slots in order to transmit wireless power by using a time-division method, wherein wireless power is simultaneously transmitted to two or more wireless charging devices from at least one of the two or more slots, wherein each of the two or more slots includes a charge section simultaneously transmitting wireless power to the two or more wireless charging devices, and a request section transmitting a power reception status request from the wireless power supplying device to the wireless charging device, and wherein a length of the request section is variable. Herein, when the multi-node wireless power transmitting system performs time-division power transmission, power transmission may be simultaneously performed to multiple nodes during one time slot, thereby enabling efficient simultaneous charging to be carried out.

However, the invention presented above is disadvantageous in that, when transmitting power to multiple nodes, a time-division method is used, wherein time is fragmented and power is exchanged, allocated, and supplied for a smooth distribution of power, which is irrelevant to the technology that enables quick charging and full charging to be carried out simultaneously.

Therefore, the development of a wireless power transmitting device equipped with a controlling means capable of simultaneously charging diverse devices having different charging currents for each entity and, most particularly, simultaneously carrying out quick charging and full charging is urgently required.

### SUMMARY OF THE INVENTION

Accordingly, the present invention is directed to a multi charging device enabled by current and voltage control that substantially obviates one or more problems due to limitations and disadvantages of the related art.

A technical object of the present invention is to provide a multi charging device enabled by current and voltage control that enables devices capable being charged by using a quick charging method due to a large charging capacity to be charged in a main charging unit, which is capable of performing both quick charging and full charging, and that enables devices having trouble being charged by using the quick charging method due to a low charging capacity to be charged in an auxiliary charging unit, which is only capable of performing full charging.

Also, another object of the present invention is to provide a multi charging device enabled by current and voltage control that is equipped with a voltage/current control module, which varies the power level that is required for performing charging by controlling the size of the charging current in the main charging unit, and that enables the main charging unit and the auxiliary charging unit to respectively charge their target devices using different power levels at the same time without interfering with one another by having the auxiliary charging unit simply receive the power controlled by the voltage/current control module.

Yet another object of the present invention is to provide a multi charging device enabled by current and voltage control that enables charging of low power capacity wearable devices, which have recently been used at an increasing frequency rate, to be carried out by using an auxiliary charging unit being subordinate to a main charging unit in a single charging device and having a very simple configuration, without having to manufacture any separate (or independent) charging devices, thereby resolving diverse problems caused by a separate configuration of a charging device.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, according to an exemplary embodiment of the present invention, provided herein is a multi charging device enabled by current and voltage control being configured to include a main charging unit being capable of changing a charging speed, and at least one auxiliary charging unit being connected to the main charging unit by a wired connection and being incapable of changing the charging speed, wherein the main charging unit includes a power input module being supplied with power from an external power source, a voltage/current control module controlling voltage and current of the power being delivered from the power input module so as to vary the voltage and current, a variable charging module being supplied with voltage/current in accordance with a size that is varied by the voltage/current control module and performing wireless charging of devices, and a power output module being supplied with specific voltage/current controlled by the voltage/current control module and supplying power to the auxiliary charging unit, and wherein the at least one auxiliary charging unit includes a non-variable charging module being supplied with the specific voltage/current from the power output module and performing wireless charging of devices.

Preferably, the main charging unit may include a first docking station holding a target device and having a transmitting unit installed therein, a first bottom supporting unit coupled with the first docking station so as to provide support and supporting a bottom surface, a first cable connecting part being formed on one side of the first bottom supporting unit and being connected to a cable provided to connect the main charging unit and the auxiliary charging unit, and a power cable being extracted from another side of the first bottom supporting unit and receiving the power being supplied to the power input module from a power source.

Preferably, the first docking station may have a flat plane surface so as to hold a device, and the flat plane surface may form a predetermined inclination angle with the first bottom supporting unit.

Preferably, the auxiliary charging unit may include a second docking station holding a target device and having a transmitting unit installed therein, a second bottom supporting unit coupled with the second docking station so as to provide support and supporting a bottom surface, and a second cable connecting part being formed on one side of the second bottom supporting unit and being connected to a cable provided to connect the main charging unit and the auxiliary charging unit.

Preferably, the second docking station may be perpendicular to the second bottom supporting unit or form a predetermined inclination angle with the second bottom supporting unit.

Preferably, the second docking station may hold a wearable device.

Preferably, a current being supplied through the power input module may be branched to a charging current of the main charging unit and a charging current of the auxiliary charging unit by the voltage/current control module, and each type of charging current may be independently controlled.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates a perspective view showing a charging device capable of performing multi-charging according to an exemplary embodiment of the present invention.

FIG. 2 illustrates an exploded view showing a main charging unit according to an exemplary embodiment of the present invention.

FIG. 3 illustrates an exploded view showing an auxiliary charging unit according to an exemplary embodiment of the present invention.

FIG. 4 illustrates a block view showing each component module of the main charging unit according to the exemplary embodiment of the present invention.

FIG. 5 illustrates a perspective view showing a charging device capable of performing multi-charging according to another exemplary embodiment of the present invention.

### DETAILED DESCRIPTION OF THE INVENTION

Hereinafter, the preferred exemplary embodiments of the present invention will be described in detail with reference to the appended drawings. In describing the present invention, when it is determined that the detailed description on a related disclosed technology may cause ambiguity in the concept (or idea) of the present invention, the detailed description of the same will be omitted for simplicity.

The terms used in the description of the present invention are defined based on their corresponding functions within the present invention. And, since the meaning of such terms may vary in accordance with the intentions or practices of anyone skilled in the art, the definition of the terms used in the description of the present invention should be understood based on the overall context of this specification.

Additionally, it should be noted that, among the component modules, detailed description on the disclosed modules will not be separately provided

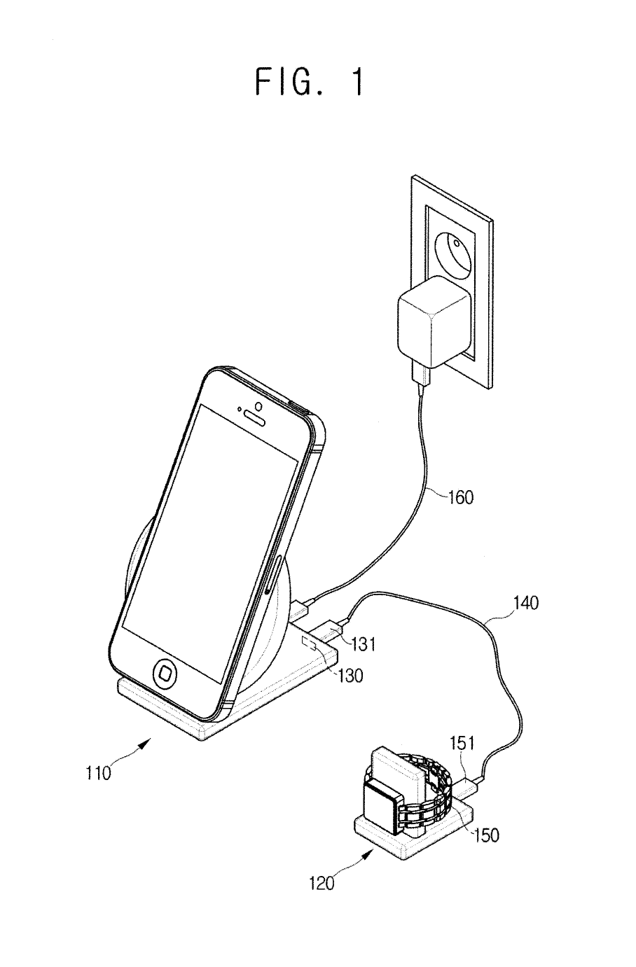

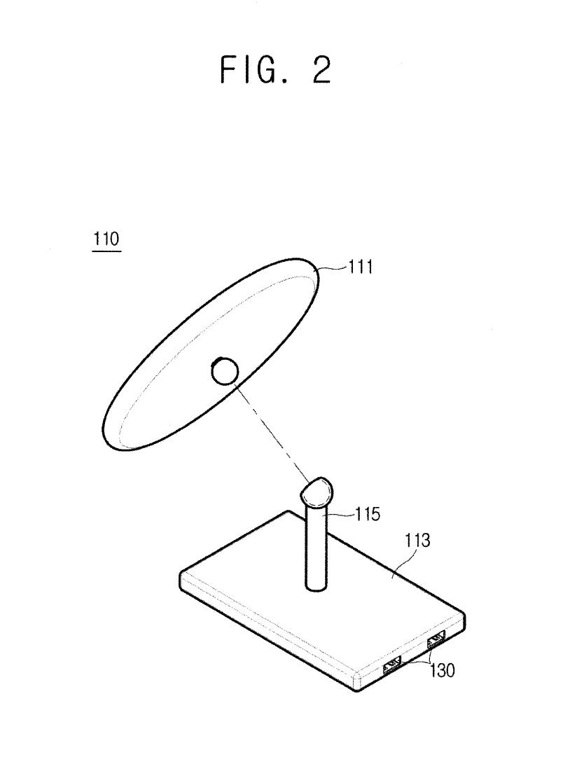

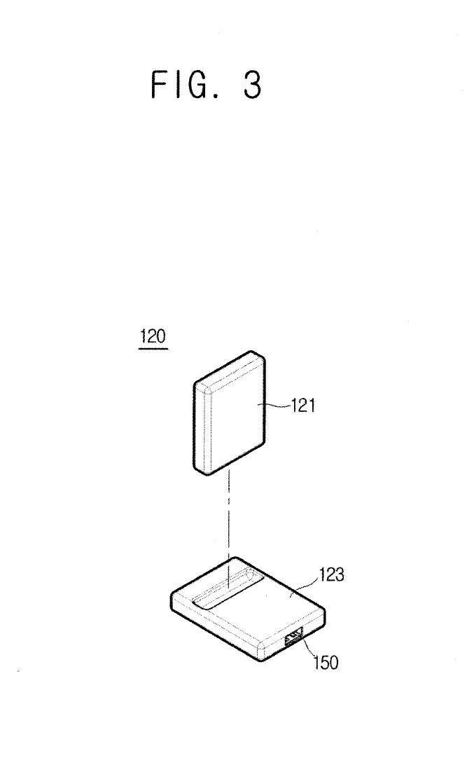

FIG. 1 illustrates a perspective view showing a charging device capable of performing multi-charging according to an exemplary embodiment of the present invention. FIG. 2 illustrates an exploded view showing a main charging unit according to an exemplary embodiment of the present invention. And, FIG. 3 illustrates an exploded view showing an auxiliary charging unit according to an exemplary embodiment of the present invention.

As shown in the drawing, a multi charging device according to the present invention includes a main charging unit 110 being capable of changing a charging speed, and at least one auxiliary charging unit 120 being connected to the main charging unit 110 by a wired connection and being incapable of changing the charging speed.

Herein, the main charging unit 110 includes a first docking station 111 holding a target device for device (hereinafter referred to as “target device”) and having a transmitting unit installed therein, a first bottom supporting unit 113 coupled with the first docking station 111 so as to provide support and supporting a bottom surface, a first cable connecting part 130 being formed on one side of the first bottom supporting unit 113 and being connected to a cable provided to connect the main charging unit 110 and the auxiliary charging unit 120, and a power cable 160 being extracted from another side of the first bottom supporting unit 113 and receiving power being supplied to the power input module from a power source.

More specifically, since the main charging unit 110 includes a power cable 160, the main charging unit 110 primarily receives power that is required for direct charging, and, then, the main charging unit 110 distributes power to the auxiliary charging unit 120, which will be described later on in more detail.

In the main charging unit 110, a target device is held by the first docking station 111, wherein the holding surface is formed as a flat plane surface. A transmitting unit including a coil, an opening/closing material, and so on, is installed in the first docking station 111. Since the transmitting unit corresponds to a disclosed component, a detailed description of the same will be omitted for simplicity. Detailed description on a transmitting unit that is provided in a second docking station 121, which will be described later on in more detail, will also be omitted for simplicity.

In order to stably hold the device, the first docking station 111 is obliquely coupled with the main charging unit 110 so as to form a predetermined inclination angle from a bottom surface. In order to allow the first docking station 111 to be obliquely coupled with the main charging unit 110, a pillar 115 may be provided between the first docking station 111 and a first bottom supporting unit 113, which will be described later on in more detail. The above-described first docking station 111 is generally used for charging standardized heavy devices, such as mobile phones, notepads, and so on. Evidently, the target devices for charging will not be limited only to the devices that are listed above.

The main charging unit 110 includes a first bottom supporting unit 113, which performs a function of supporting the main charging unit 110 by being in close contact with a bottom surface, thereby preventing the main charging unit 110 from tipping over even when the target device is held by the first docking station 111. A disclosed component, such as a friction material, may be formed on the bottom surface of the first bottom supporting unit 113.

A first cable connecting part 130, which is connected to a cable 140 for connecting the main charging unit 110 and the auxiliary charging unit 120, is provided in the first bottom supporting unit 113. The first cable connecting part 130 is electrically connected to a second cable connecting part 150, which will be described later on in more detail, by the cable 140.

Additionally, a power cable 160 is extracted from the first bottom supporting unit 113 so as to be connected to a power cord.

The auxiliary charging unit 120 is subordinate to the main charging unit 110, and, therefore, the auxiliary charging unit 120 cannot perform any charging function by itself. More specifically, the auxiliary charging unit 120 does not include any power cable 160 and merely configures a local charging unit, which is controlled by the main charging unit 110, by being connected to the main charging unit 110 through the cable 140.

The auxiliary charging unit 120 is equipped with a second docking station 121 and a second bottom supporting unit 123. Herein, unlike the first docking station 111, the second docking station 121 is obliquely coupled with the second bottom supporting unit 123 by forming a predetermined angle with the bottom surface or by being perpendicular to the bottom surface. More specifically, unlike the main charging unit 110, in the auxiliary charging unit 120, it is preferable that the second docking station 121 is perpendicular to the bottom surface so that wearable devices, such as watches, bands, headsets, and so on, can be easily held by the second docking station 121. Evidently, the devices that are charged by the auxiliary charging unit 120 will not be limited only to the devices that are listed above.

As described above, the auxiliary charging unit 120 is subordinate to the main charging unit 110, and, therefore, the auxiliary charging unit 120 cannot perform any charging functions by itself. Therefore, a second cable connecting part 150 is provided on one side of the second bottom supporting unit 123 of the auxiliary charging unit 120, thereby being connected to the first cable connecting part 130, which is provided in the main charging unit 110, by a wired connection. Thus, the auxiliary charging unit 120 may perform charging functions along with the operation of the main charging unit 110.

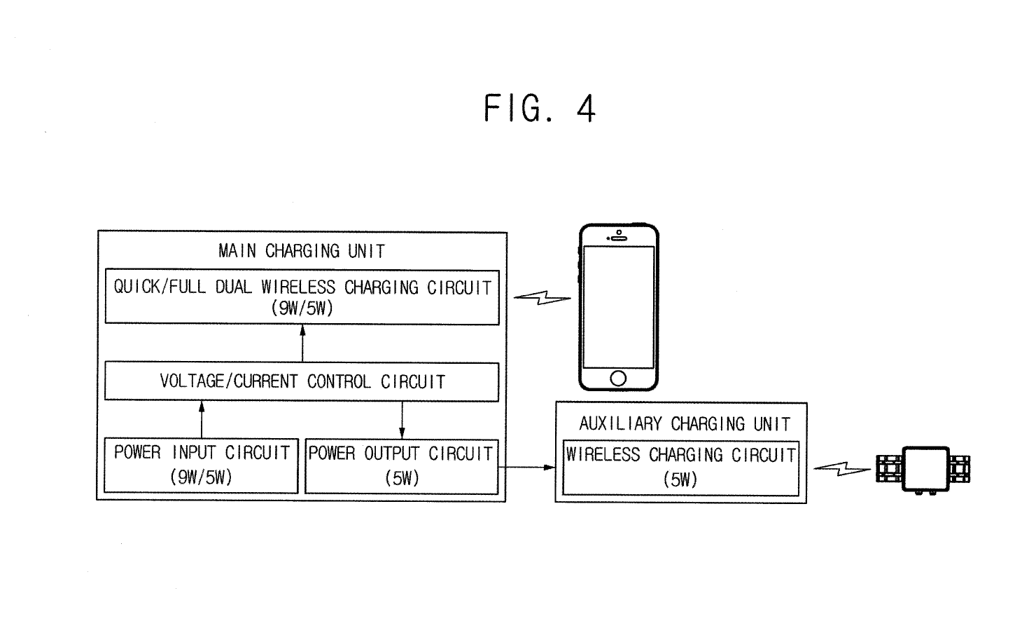

FIG. 4 illustrates a block view showing each component module of the main charging unit 110 according to the exemplary embodiment of the present invention.

As shown in the drawing, the main charging unit 110 is configured by including a power input module being supplied with power from an external power source, a voltage/current control module controlling voltage and current of the power being delivered from the power input module so as to vary the voltage and current, a variable charging module being supplied with voltage/current in accordance with a size that is varied by the voltage/current control module and performing wireless charging of devices, and a power output module being supplied with specific voltage/current controlled by the voltage/current control module and supplying power to the auxiliary charging unit.

When the main charging unit 110 is connected to a power source, the received power is received by a power input circuit. Then, any one of the quick charging method and the full charging method is selected as needed, and, then, the voltage/current is controlled and delivered to the variable charging module. And, accordingly, the charging of the device that is held is started. In order to perform such selection, a switch may be installed on one side of an outer surface of the main charging unit 110.

The variable charging module corresponds to a component of the transmitting unit and controls charging operations of the transmitting unit.

Also, the voltage/current control module controls a current size of the inputted power and supplies a power level that is adequate to the charging capacity of the auxiliary charging unit 120. This operation is mediated by the power output module. The power level received by the auxiliary charging unit 120 is determined in advance, and the power level is set to a low power level value for the power charging of a wearable device having a low charging capacity and a low power usage level. As described, when the non-variable charging module receives power that is transmitted from the power output module, the charging of the auxiliary charging unit 120 is initiated.

Although it is not shown in the drawing, a switch may be further provided on one side of the auxiliary charging unit 120, wherein the switch controls on/off states of the current.

One of the characteristics of the present invention is that the auxiliary charging unit 120 may perform charging at a predetermined power level at the same time as the main charging unit 110 regardless of the power level value according to which the main charging unit 110 performs charging, i.e., regardless of whether the main charging unit 110 performs quick charging or full charging. More specifically, the main charging unit 110 and the auxiliary charging unit 120 may be independently performed from one another, and, therefore, mutual interference does not occur between the main charging unit 110 and the auxiliary charging unit 120.

According to the present invention, the current being applied through the power input module may be branched to a charging current of the main charging unit 110 and a charging current of the auxiliary charging unit 120 by the voltage/current control module. Herein, each charging current is independently controlled, and this signifies that each of the value of the current level being provided to the variable charging module and the value of the current level being provided to the non-variable charging module is independently managed. This also signifies that, when performing dual charging (or simultaneous charging), the current levels do not cause any malfunction during the charging process.

The voltage/current control module performs a function of distributing the currents that are being supplied from the power input module. Since each of the distributed currents is independently delivered to each of the corresponding charging units, interference does not occur between the currents. This is an important characteristic of the present invention.

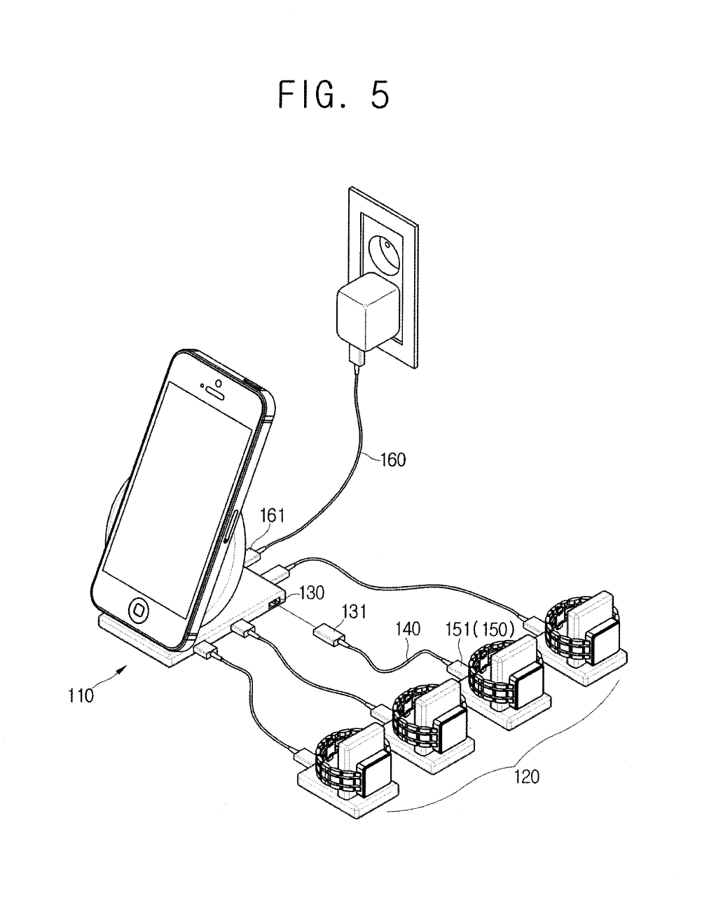

FIG. 5 illustrates a perspective view showing a charging device capable of performing multi-charging according to another exemplary embodiment of the present invention.

As shown in the drawing, the charging device according to the present invention may be configured of one main charging unit 110 being coupled with a plurality of auxiliary charging units 120, which are subordinate to the main charging unit 110. And, as described above, the charging device according to the present invention is not configured of one main charging unit 110 being connected to a single auxiliary charging unit 120.

As described above, according to the present invention, the multi charging device enabled by current and voltage control may have the following advantages. By enabling devices capable being charged by using a quick charging method due to a large charging capacity to be charged in a main charging unit, which is capable of performing both quick charging and full charging, and by enabling devices having trouble being charged by using the quick charging method due to a low charging capacity to be charged in an auxiliary charging unit, which is only capable of performing full charging, simultaneous charging of various devices may be carried out.

Also, by being equipped with a voltage/current control module, which varies the power level that is required for performing charging by controlling the size of the charging current in the main charging unit, and by having the auxiliary charging unit simply receive the power controlled by the voltage/current control module, the main charging unit and the auxiliary charging unit may respectively charge their target devices safely by using different power levels at the same time without interfering with one another.

Furthermore, by enabling charging of low power capacity wearable devices, which have recently been used at an increasing frequency rate, to be carried out by using an auxiliary charging unit being subordinate to a main charging unit in a single charging device and having a very simple configuration, without having to manufacture any separate (or independent) charging devices, diverse problems caused by a separate configuration of a charging device may be resolved.

It will be apparent to those skilled in the art that various modifications and variations can be made in this specification without departing from the spirit or scope of this specification. Thus, it is intended that this specification covers the modifications and variations of this invention provided they come within the scope of the appended claims and their equivalents. It is also apparent that such variations of this specification are not to be understood individually or separately from the technical scope or spirit of this specification.

What is claimed is:

1. A multi charging device enabled by current and voltage control being configured to include a main charging unit being capable of changing a charging speed, and at least one auxiliary charging unit being connected to the main charging unit by a wired connection and being incapable of changing the charging speed,
wherein the main charging unit comprises:
a power input module being supplied with power from an external power source,
a voltage/current control module controlling voltage and current of the power being delivered from the power input module so as to vary the voltage and current,
a variable charging module being supplied with voltage/current in accordance with a size that is varied by the voltage/current control module and performing wireless charging of devices, and
a power output module being supplied with specific voltage/current controlled by the voltage/current control module and supplying power to the auxiliary charging unit, and
wherein the at least one auxiliary charging unit comprises:
a non-variable charging module being supplied with the specific voltage/current from the power output module and performing wireless charging of devices.

2. The device of claim 1, wherein the main charging unit comprises:
a first docking station holding a target device and having a transmitting unit installed therein;
a first bottom supporting unit coupled with the first docking station so as to provide support and supporting a bottom surface;
a first cable connecting part being formed on one side of the first bottom supporting unit and being connected to a cable provided to connect the main charging unit and the auxiliary charging unit; and
a power cable being extracted from another side of the first bottom supporting unit and receiving the power being supplied to the power input module from a power source.

3. The device of claim 2, wherein the first docking station has a flat plane surface so as to hold a device, and wherein the flat plane surface forms a predetermined inclination angle with the first bottom supporting unit.

4. The device of claim 1, wherein the auxiliary charging unit comprises:
a second docking station holding a target device and having a transmitting unit installed therein;
a second bottom supporting unit coupled with the second docking station so as to provide support and supporting a bottom surface; and
a second cable connecting part being formed on one side of the second bottom supporting unit and being connected to a cable provided to connect the main charging unit and the auxiliary charging unit.

5. The device of claim 4, wherein the second docking station is perpendicular to the second bottom supporting unit or forms a predetermined inclination angle with the second bottom supporting unit.

6. The device of claim 5, wherein the second docking station holds a wearable device.

7. The device of claim 1, wherein a current being supplied through the power input module is branched to a charging current of the main charging unit and a charging current of the auxiliary charging unit by the voltage/current control module, and
wherein each type of charging current is independently controlled.
